(19) United States
(12) Patent Application Publication
(10) Pub. No.: US 2024/0220573 A1
(43) Pub. Date: Jul. 4, 2024

(54) Computing in Memory Accelerator for Applying to a Neural Network

(71) Applicant: National Cheng Kung University, Tainan City (TW)

(72) Inventors: Lih-Yih Chiou, Tainan City (TW); Yun-Ru Chen, Tainan City (TW); Tsung-Chi Chen, Taichung City (TW)

(73) Assignee: National Cheng Kung University, TAINAN CITY (TW)

(21) Appl. No.: 18/118,153

(22) Filed: Mar. 7, 2023

(30) Foreign Application Priority Data
Dec. 28, 2022 (TW) 111150294

(51) Int. Cl. G06F 17/16; G06F 3/06

(52) U.S. Cl. CPC G06F 17/16; G06F 3/0613; G06F 3/0656; G06F 3/0673; G06N 3/08

(57) ABSTRACT

A computing in memory accelerator for applying to a neural network includes a memory, a data buffer unit, a pooling unit, a loss computing unit, a first macro circuit, a second macro unit, a third macro unit, and a multiplexer. The memory is used for saving data. The data buffer unit is coupled to the memory and used to buffer data outputted from the memory. The pooling unit is coupled to the memory and used to pool data for acquiring a maximum pooling value. The loss computing unit is coupled to the memory and used to compute output loss. The first macro circuit, the second macro unit, and the third macro unit are coupled to the data buffer unit. The multiplexer is coupled to the pooling unit, the first macro circuit, the second macro unit, and the third macro unit and used to generate output data.

### BACKGROUND OF THE INVENTION

### 1. Field of the Invention

The present invention illustrates a computing in memory accelerator for applying to a neural network, and more particularly, a computing in memory accelerator for performing neural network training mechanism and neural network by using a plurality of macro circuits.

### 2. Description of the Prior Art

The idea of artificial neural networks has existed for a long time. Nevertheless, limited computation ability of hardware has been an obstacle to related researches. Over the last decade, there are significant progresses in computation capabilities of processors and algorithms of machine learning. Not until recently did an artificial neural network that can generate reliable judgments become possible. Gradually, artificial neural networks are experimented in many fields such as autonomous vehicles, image recognitions, natural language understanding applications, and data mining applications.

Neurons are the basic computation units in a brain. Each neuron receives input signals from its dendrites and produces output signals along with its single axon (i.e., usually provided to other neurons as input signals). The typical operation of an artificial neuron can be modeled as:

$$y = f ( {\sum }_{i} {w}_{i} {x}_{i} + b )$$

Here, xᵢ represents an input signal of i-th source, y represents an output signal. Each dendrite multiplies a weighting wᵢ to its corresponding input signal xᵢ for simulating the strength of influence of one neuron on another. b represents a bias contributed by the artificial neuron itself. f(·) represents as a specific transfer function, which is generally implemented as a sigmoid function, a hyperbolic tangent function, or a rectified linear function in a practical computation.

Further, in recent years, with the development of artificial intelligence and combinations of the artificial intelligence with networked devices, requirements of edge devices applied to the artificial intelligence capable of performing deep-learning or machine learning computing capabilities are increased. After the trained neural network models of a cloud are allocated to the edge devices, in order to satisfy user's actual requirements, the neural network must be retrained for optimizing its performance.

Considering time delay caused by data communications between the edge devices and the cloud through the network, since the user's private data may be hacked, it is indispensable for the edge devices to be capable of performing an on-chip training function. Therefore, to develop a neural network accelerator capable of performing the on-chip training function under limited power consumption is an important design issue.

### SUMMARY OF THE INVENTION

In an embodiment of the present invention, a computing in memory accelerator for applying to a neural network is disclosed. The accelerator comprises a memory, a data buffer unit, a pooling unit, a loss computing unit, a first macro circuit, a second macro circuit, a third macro circuit, and a multiplexer. The memory is configured to save data. The data buffer unit is coupled to the memory and configured to buffer data outputted from the memory. The pooling unit is coupled to the memory and configured to pool data for acquiring a maximum pooling value. The loss computing unit is coupled to the memory and configured to compute output loss. The first macro circuit is coupled to the data buffer unit. The second macro circuit is coupled to the data buffer unit. The third macro circuit is coupled to the data buffer unit and the loss computing unit. The multiplexer is coupled to the pooling unit, the first macro circuit, the second macro circuit, and the third macro circuit and configured to generate output data. An output terminal of the multiplexer is coupled to an input terminal of the memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a computing in memory accelerator for applying to a neural network according to an embodiment of the present invention.

FIG. 2A is a block diagram of a first macro circuit of the computing in memory accelerator in FIG. 1.

FIG. 2B is an illustration of input/output pins of a first macro unit of the first macro circuit of the computing in memory accelerator in FIG. 2A.

FIG. 2C is an illustration of generating outputs by linearly combining inputs of the first macro unit of the first macro circuit of the computing in memory accelerator in FIG. 2A.

FIG. 3A is a block diagram of a second macro circuit of the computing in memory accelerator in FIG. 1.

FIG. 3B is an illustration of input/output pins of a second macro unit of the second macro circuit of the computing in memory accelerator in FIG. 3A.

FIG. 3C is an illustration of generating outputs by linearly combining inputs of the second macro unit of the second macro circuit of the computing in memory accelerator in FIG. 3A.

FIG. 4A is a block diagram of a third macro circuit of the computing in memory accelerator in FIG. 1.

FIG. 4B is an illustration of input/output pins of a third macro unit of the third macro circuit of the computing in memory accelerator in FIG. 4A.

FIG. 4C is an illustration of generating outputs by linearly combining inputs of the third macro unit of the third macro circuit of the computing in memory accelerator in FIG. 4A.

### DETAILED DESCRIPTION

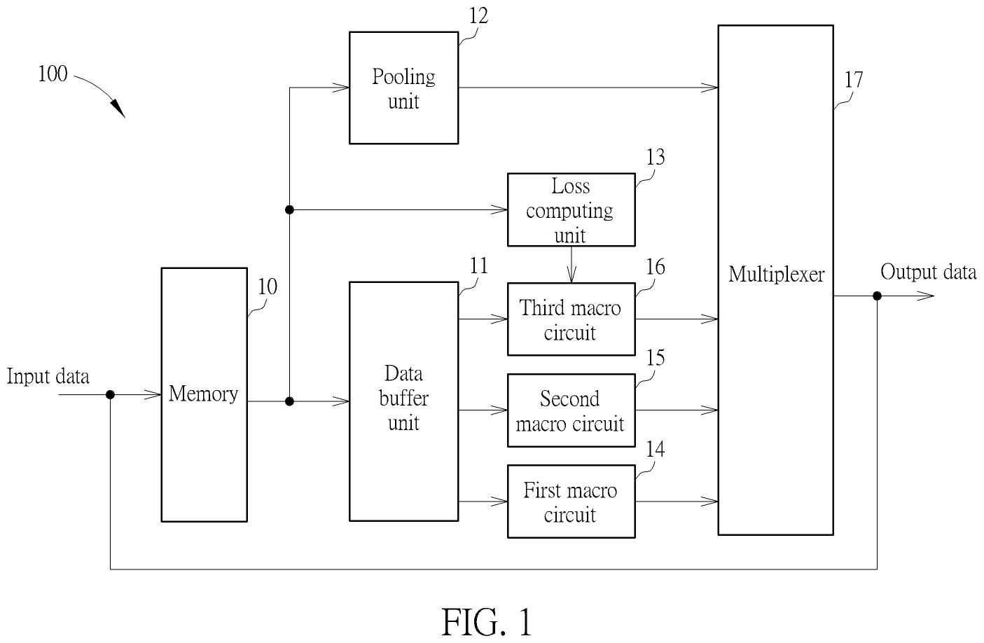

FIG. 1 is a block diagram of a computing in memory accelerator 100 for applying to a neural network according to an embodiment of the present invention. For simplicity, the computing in memory accelerator 100 for applying to the neural network is called as an accelerator 100 hereafter. The accelerator 100 is a computing in Memory (CIM) accelerator for optimizing the latency of accessing data or moving data when the neural network is performed. The accelerator 100 can be applied to any neural network operation, such as an incremental learning operation. Further, the accelerator 100 can be implemented by an electronic system, the details are as follows. The accelerator 100 includes a memory 10, a data buffer unit 11, a pooling unit 12, a loss computing unit 13, a first macro circuit 14, a second macro circuit 15, a third macro circuit 16, and a multiplexer 17. The memory 10 is used for saving input data. The memory 10 can be a static random access memory (SRAM). The data buffer unit 11 is coupled to the memory 10 for buffering data outputted from the memory 10. The pooling unit 12 is coupled to the memory 10 for pooling data outputted from the memory 10 for acquiring a maximum pooling value (Max Pooling). For example, the pooling unit 12 can acquire a maximum value from each group of data matrices to extract essential features. Then, since the data matrices can be converged, the pooling unit 12 can reduce dimensions of the data matrices. The loss computing unit 13 is coupled to the memory 10 for computing output loss. The first macro circuit 14 is coupled to the data buffer unit 11. The second macro circuit 15 is coupled to the data buffer unit 11. The third macro circuit 16 is coupled to the data buffer unit 11 and the loss computing unit 13. The multiplexer 17 is coupled to the pooling unit 12, the first macro circuit 14, the second macro circuit 15, and the third macro circuit 16 for generating output data. The output terminal of the multiplexer 17 is coupled to the input terminal of the memory 10. In the accelerator 100, since the application of the incremental learning mechanism can be realized, forward propagation, weighting update, and back propagation operations are introduced for facilitating the incremental learning mechanism. Therefore, in the accelerator 100, the first macro circuit 14, the second macro circuit 15, and the third macro circuit 16 can be introduced. Finally, the multiplexer 17 can select an output of one macro circuit. Then, the output can be transmitted back to the memory 10 and can be used for training the neural network in a next loop. The three macro functions and circuits introduced by the accelerator 100 (i.e., the first macro circuit 14, the second macro circuit 15, and the third macro circuit 16) are illustrated later.

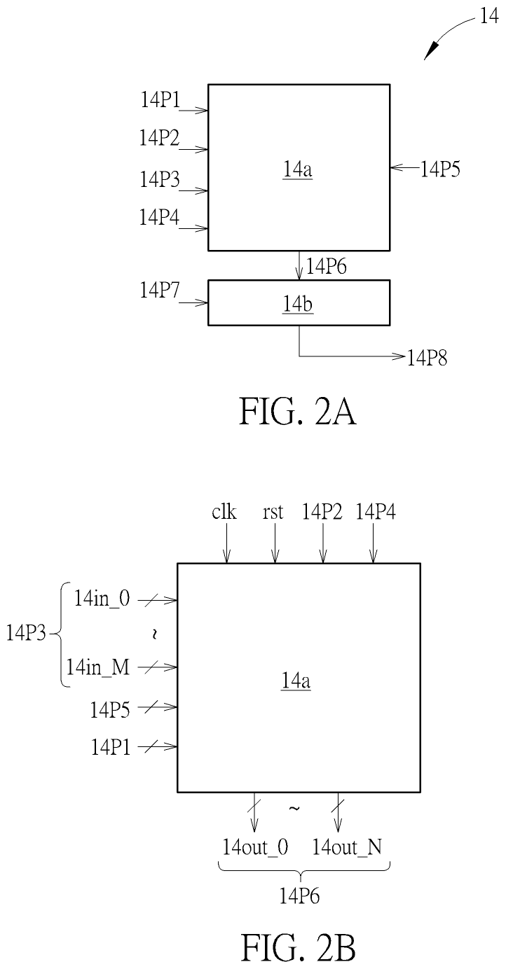

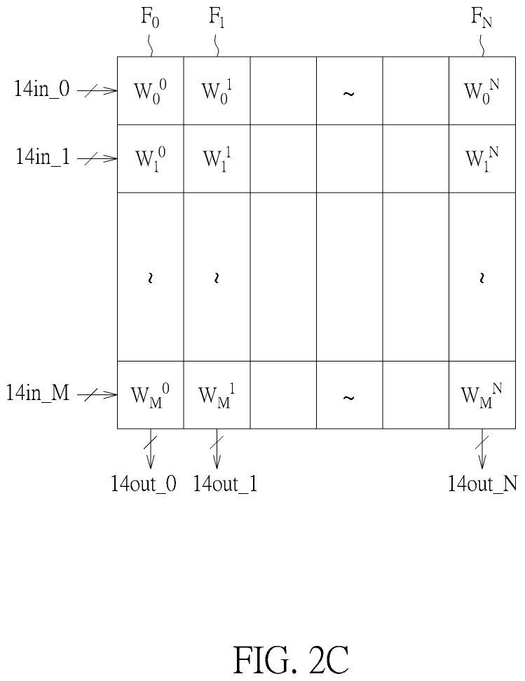

FIG. 2A is a block diagram of the first macro circuit 14 of the computing in memory accelerator 100. The first macro circuit 14 includes a first macro unit 14a and a calculating activation unit 14b. The first macro unit 14a includes a first input terminal, a second input terminal, a third input terminal, a fourth input terminal, a fifth input terminal, and an output terminal. The first input terminal is used for receiving address information 14P1. The second input terminal is used for receiving the read/write control information 14P2. The third input terminal is used for receiving input feature information 14P3. The fourth input terminal is used for receiving activation information 14P4. The fifth input terminal is used for receiving weighting information 14P5. The output terminal is used to transmit an output signal 14P6. Here, the first macro circuit 14 can be applied to perform the forward propagation operation. The first macro circuit 14 further includes a calculating activation unit 14b. The calculating activation unit 14b includes a first input terminal, a second input terminal, and an output terminal. The first input terminal is coupled to the output terminal of the first macro unit 14a for receiving the output signal 14P6 generated by the first macro unit 14a. The second input terminal is used for receiving calculating activation mode information 14P7. The output terminal is used to transmit an output signal 14P8. Further, the first macro circuit 14 may be a calculated convolution (MAC) circuit. After the first macro unit 14a is combined with the calculating activation unit 14b, the forward propagation operation can be performed.

FIG. 2B is an illustration of input/output pins of the first macro unit 14a of the first macro circuit 14 of the computing in memory accelerator 100. As mentioned previously, the third input terminal of the first macro unit 14a can be used for receiving the input feature information 14P3. For example, the input feature information 14P3 received by the third input terminal of the first macro unit 14a may include an input feature vector having (M+1) dimensions, denoted as input features 14in_0 to 14in_M in FIG. 2B. Further, the output terminal of the first macro unit 14a can be used to transmit the output signal 14P6. For example, the output terminal of the first macro unit 14a can be used to output an output vector having (N+1) dimensions, denoted as output signals 14out_0 to 14out_N in FIG. 2B. Further, the first macro unit 14a further includes a clock control terminal clk and a reset terminal rst. M and N are two positive integers. Residue input/output terminals of the first macro unit 14a are shown in FIG. 2A. Therefore, details are omitted there.

FIG. 2C is an illustration of generating outputs by linearly combining inputs of the first macro unit 14a of the first macro circuit 14 of the computing in memory accelerator 100. As mentioned previously, the input feature information 14P3 received by the third input terminal of the first macro unit 14a may include the input features 14in_0 to 14in_M. After the first macro unit 14a receives the weighting information 14p5 through the fifth input terminal, the first macro unit 14a can generate (M+1)×(N+1) weightings, denoted as W₀⁰ to W_{M}^{N}. Further, after (M+1) weightings of each column are linearly combined with the input feature vector having (M+1) dimensions, an output of the first macro unit 14a can be generated. For example, the output feature 14out_n can be expressed as:

$$14 out\_n = {\sum }_{i = 0}^{M} input i * {W}_{i}^{n}$$

Here, input i is denoted as the i-th input feature 14in_i. As mentioned previously, in the first macro unit 14a, the (M+1) weightings of each column are linearly combined with the input feature vector having (M+1) dimensions. Therefore, in an (M+1)×(N+1) data mapping matrix, operations of each column can be regarded as (N+1) filters, denoted as F0 to FN in FIG. 2C. After the first macro unit 14a outputs the output vector having (N+1) dimensions, the output vector having (N+1) dimensions can be transmitted to the calculating activation unit 14b for calculating parameters of the activation function used by subsequent processes.

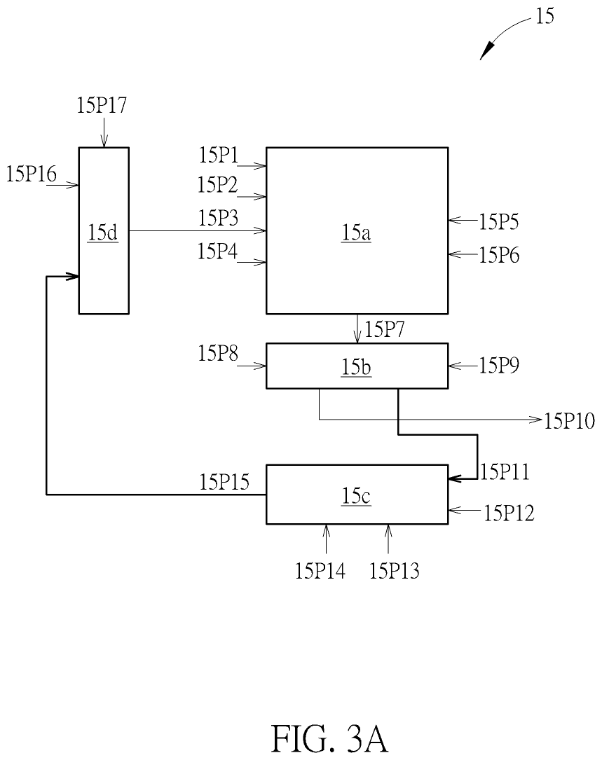

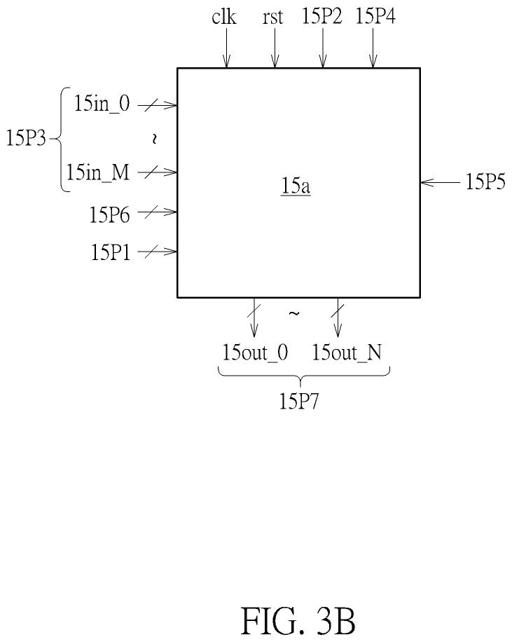

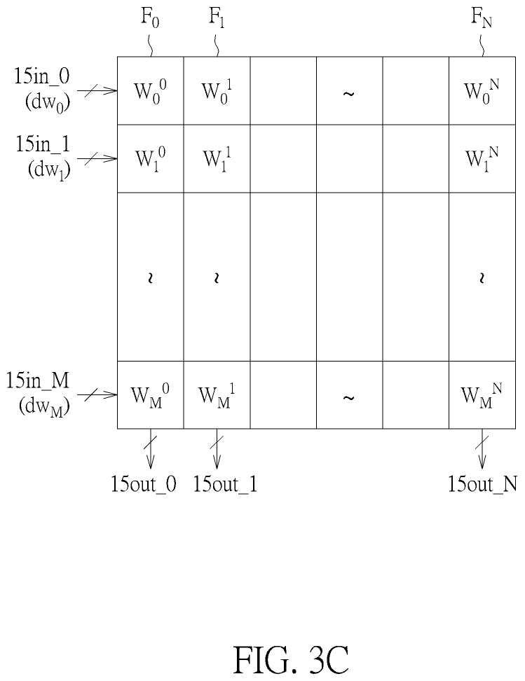

FIG. 3A is a block diagram of a second macro circuit 15 of the computing in memory accelerator 100. The second macro circuit 15 includes a second macro unit 15a, a calculating activation and derivative unit 15b, a weighting gradient calculation unit 15c, and an input multiplexer 15d. The second macro unit 15a includes a first input terminal, a second input terminal, a third input terminal, a fourth input terminal, a fifth input terminal, a sixth input terminal, and an output terminal. The first input terminal is used for receiving address information 15P1. The second input terminal is used for receiving read/write control information 15P2. The third input terminal is used for receiving input feature information 15P3. The fourth input terminal is used for receiving activation information 15P4. The fifth input terminal is used for receiving weight updating information 15P5. The sixth input terminal is used for receiving weight information 15P6. The output terminal is used to transmit an output signal 15P7. Here, the second macro circuit 15 can be introduced for performing a weighting update operation. The second macro circuit 15 also includes the calculating activation and derivative unit 15b. The calculating activation and derivative unit 15b includes a first input terminal, a second input terminal, a third input terminal, a first output terminal, and a second output terminal. The first input terminal is coupled to the output terminal of the second macro unit 15P7. The second input terminal is used for receiving calculating activation mode information 15P8. The third input terminal is used for receiving the first variation information 15P9. The first output terminal is used to transmit an output signal 15P10. The second output end is used to output second variation information 15P11. Here, the first variation information 15P9 can be layer output gradient information, expressed as ∂C/∂A. The second variation information 15P11 can be derivative information of the pre-activation gradient, expressed as ∂C/∂Z. Correlations between ∂C/∂A and ∂C/∂Z can be expressed as:

$$\frac{\partial C}{\partial {z}^{l}} = \frac{\partial {a}^{l}}{\partial {z}^{l}} * \frac{\partial C}{\partial {a}^{l}} = \frac{\partial {a}^{l}}{\partial {z}^{l}} * {\sum }_{o = 1}^{O} \frac{\partial C}{\partial {z}_{o}^{l + 1}} * {w}_{o}^{l + 1}$$

Here, C is an output of 1-th layer. 1 is a positive integer. W is the weighting. The second macro circuit 15 can include a weighting gradient calculation unit 15c. The weighting gradient calculation unit 15c includes a first input terminal, a second input terminal, a third input terminal, a fourth input terminal, and an output terminal. The first input terminal is coupled to the output terminal of the calculating activation and derivative unit 15b for receiving the output signal 15P11. The second input terminal is used for receiving input feature information 15P12. The third input terminal is used for receiving an output control signal 15P13. The fourth input terminal is used for receiving the computing control signal 15P14. The output terminal is used for outputting the third variation information 15P15. Here, the third variation information 15P15 can include partial differential derivative information, expressed as ∂L/∂W. Moreover, correlations between ∂L/∂W and ∂C/∂Z can be expressed as:

$$\frac{\partial L}{\partial w} = \frac{1}{N} {\sum }_{n = 1}^{N} i * \frac{\partial C}{\partial z}$$

The second macro circuit 15 further includes an input multiplexer 15d. The input multiplexer 15d includes a first input terminal, a second input terminal, an output terminal, and a control terminal. The first input terminal is used for receiving input feature information 15P16. The second input terminal is coupled to the output terminal of the weighting gradient calculation unit 15c. The output terminal is coupled to the third input terminal of the second macro unit 15a. The control terminal is used for receiving a selection signal 15P17. Further, the second macro circuit 15a may be the calculated convolution (MAC) circuit in conjunction with a weighting update circuit. After the second macro unit 15a is combined with the calculating activation and derivative unit 15b and the weighting gradient calculation unit 15c, the forward propagation operation and the weighting update operation can be implemented.

FIG. 3B is an illustration of input/output pins of the second macro unit 15a of the second macro circuit 15 of the computing in memory accelerator 100. As mentioned previously, the third input terminal of the second macro unit 15a can be used for receiving the input feature information 15P3. For example, the input feature information 15P3 received by the third input terminal of the second macro unit 15a may include an input feature vector having (M+1) dimensions, denoted as input features 15in_0 to 15in_M in FIG. 3B. Further, the output terminal of the second macro unit 15a can be used to transmit the output signal 15P7. For example, the output terminal of the second macro unit 15a can be used to output an output vector having (N+1) dimensions, denoted as output signals 15out_0 to 15out_N in FIG. 3B. Further, the second macro unit 15a further includes a clock control terminal clk and a reset terminal rst. M and N are two positive integers. Residue input/output terminals of the second macro unit 15a are shown in FIG. 3A. Therefore, details are omitted there.

FIG. 3C is an illustration of generating outputs by linearly combining inputs of the second macro unit 15a of the second macro circuit 15 of the computing in memory accelerator 100. As mentioned previously, the input feature information 15P3 received by the third input terminal of the second macro unit 15a may include the input features 15in_0 to 15in_M. Further, the third input terminal of the second macro unit 15a can be used for receiving (M+1) weighting difference information, denoted as dw₀ to dw_{M}. After the second macro unit 15a receives the weighting information 15P6 through the sixth input terminal, the second macro unit 15a can generate (M+1)×(N+1) weightings, denoted as W₀⁰ to W_{M}^{N}. Further, after (M+1) weightings of each column are linearly combined with the input feature vector having (M+1) dimensions, an output of the second macro unit 15a can be generated. For example, the output feature 15out_n can be expressed as:

$$15 out\_n = {\sum }_{i = 0}^{M} input i * {W}_{i}^{n}$$

As mentioned previously, the second macro circuit 15 can perform the weighting updating function. Therefore, after (M+1) weighting differences dw₀ to dw_{M} are received by the third input terminal of the second macro unit 15a, i-th updated weighting Wᵢⁿ′ of the n-th column can be expressed as:

$${w}_{i}^{n ′} = {w}_{i}^{n} - {dw}_{i}$$

In other words, for (M+1)×(N+1) weightings of the second macro circuit 15, the (M+1) weightings of each column can be updated according to the (M+1) weighting differences. As mentioned previously, in the second macro unit 15a, the (M+1) weightings of each column are linearly combined with the input feature vector having (M+1) dimensions. Therefore, in an (M+1)×(N+1) data mapping matrix, operations of each column can be regarded as (N+1) filters, denoted as F0 to FN in FIG. 3C. Compared with the first macro circuit 14, the second macro circuit 15 has all functions of the first macro circuit 14. The second macro circuit 15 can further perform a function of updating weights. Therefore, when the neural network requires performing a macro function of updating weights, the second macro circuit 15 can be used.

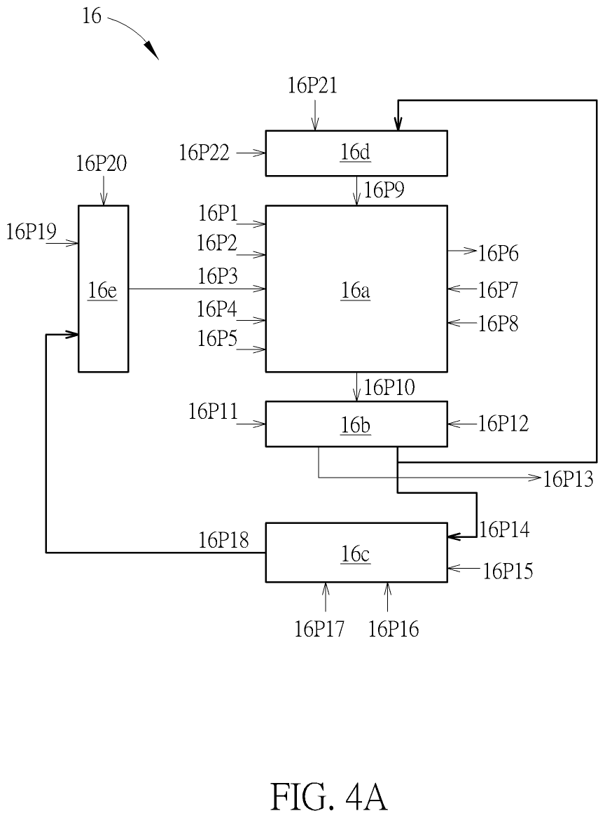

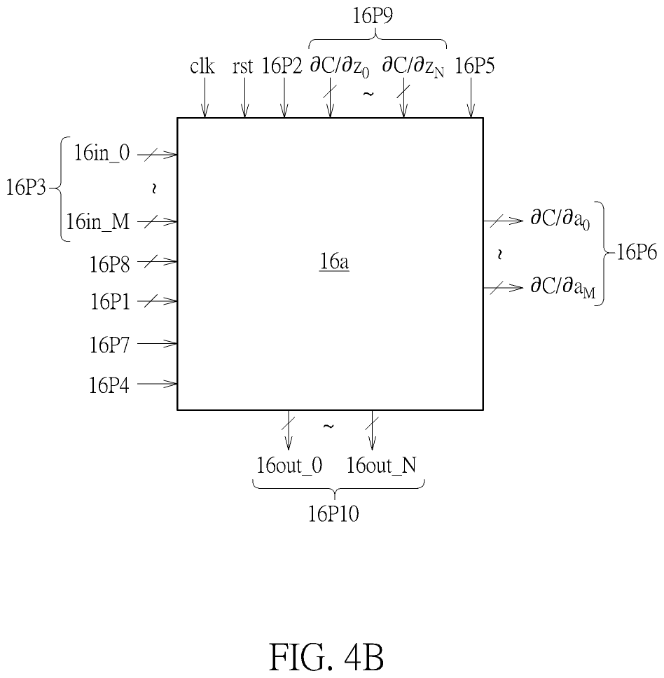

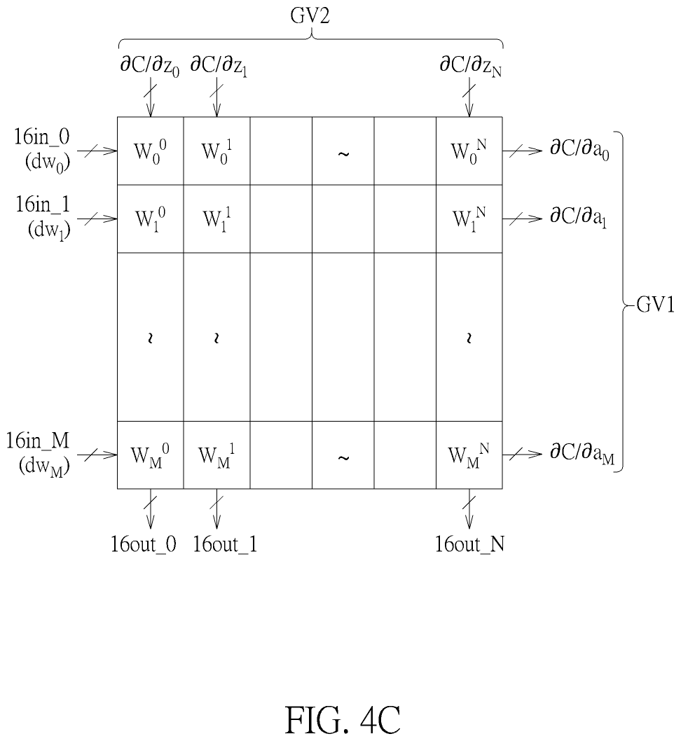

FIG. 4A is a block diagram of the third macro circuit 16 of the computing in memory accelerator 100. The third macro circuit 16 includes a third macro unit 16a, a calculating activation and derivative unit 16b, a weighting gradient calculation unit 16c, a derivative input multiplexer 16d, and an input multiplexer 16e. The third macro unit 16a includes a first input terminal, a second input terminal, a third input terminal, a fourth input terminal, a fifth input terminal, a sixth input terminal, a seventh input terminal, an eighth input terminal, a first output terminal, and a second output terminal. The first input terminal is used for receiving address information 16P1. The second input terminal is used for receiving read/write control information 16P2. The third input terminal is used for receiving input feature information 16P3. The fourth input terminal is used for receiving the first activation information 16P4. The fifth input terminal is used for receiving the second activation information 16P5. The sixth input terminal is used for receiving an output signal 16P9 outputted from the derivative input multiplexer 16d. The seventh input terminal is used for receiving weighting update information 16P7. The eighth input terminal is used for receiving weighting information 16P8. The first output terminal is used for outputting first variation information 16P6. The second output terminal is used for transmitting an output signal 16P10. Here, the third macro circuit 16 can be used for calculating an output gradient of previous layers. The third macro circuit 16 further includes a calculating activation and derivative unit 16b. The calculating activation and derivative unit 16b includes a first input terminal, a second input terminal, a third input terminal, a first output terminal, and a second output terminal. The first input terminal is coupled to the second output terminal of the third macro unit 16a. The second input terminal is used for receiving calculating activation mode information 16P11. The third input terminal is used for receiving first variation information 16P12. The first output terminal is used for transmitting an output signal 16P13. The second output terminal is used for outputting second variation information 16P14. Here, the first variation information 16P12 can be the layer output gradient information, expressed as dc/JA. The second variation information 16P14 can be the derivative information of the pre-activation gradient, expressed as dc/az. Correlations between ∂C/∂A and ∂C/∂Z can be expressed as:

$$\frac{\partial C}{\partial {z}^{l}} = \frac{\partial {a}^{l}}{\partial {z}^{l}} * \frac{\partial C}{\partial {a}^{l}} = \frac{\partial {a}^{l}}{\partial {z}^{l}} * {\sum }_{o = 1}^{O} \frac{\partial C}{\partial {z}_{o}^{l + 1}} * {w}_{o}^{l + 1}$$

Here, C is an output of 1-th layer. 1 is a positive integer. W is the weighting. The third macro circuit 16 can include a weighting gradient calculation unit 16c. The weighting gradient calculation unit 16c includes a first input terminal, a second input terminal, a third input terminal, a fourth input terminal, and an output terminal. The first input terminal is coupled to the second output terminal of the calculating activation and derivative unit 16b. The second input terminal is used for receiving the input feature information 16P15. The third input terminal is used for receiving an output control signal 16P16. The fourth input terminal is used for receiving a computing control signal 16P17. The output terminal is used for outputting the third variation information 16P18. Here, the third variation information 16P18 can include partial differential derivative information, expressed as ∂L/∂W. Moreover, correlations between ∂L/∂W and ∂C/∂Z can be expressed as:

$$\frac{\partial L}{\partial w} = \frac{1}{N} {\sum }_{n = 1}^{N} i * \frac{\partial C}{\partial z}$$

The third macro circuit 16 further includes an input multiplexer 16e. The input multiplexer 16e includes a first input terminal, a second input terminal, an output terminal, and a control terminal. The first input terminal is used for receiving the input feature information 16P19. The second input terminal is coupled to the output terminal of the weighting gradient calculation unit 16c. The output terminal is coupled to the third input terminal of the third macro unit 16a. The control terminal is used for receiving a selection signal 16P20. The third macro circuit 16 further includes a derivative input multiplexer 16d. The derivative input multiplexer 16d includes a first input terminal, a second input terminal, a control terminal, and an output terminal. The first input terminal is used for receiving second variation information 16P21 outputted from the loss computing unit 13. The second input terminal is coupled to the second output terminal of the calculating activation and derivative unit 16b. The control terminal is used for receiving a selection signal 16P22. The output terminal is coupled to the sixth input terminal of the third macro unit 16a. Further, the third macro circuit 16a may be the calculated convolution (MAC) circuit in conjunction with a weighting update circuit and a gradient operation circuit. After the third macro unit 16a, the calculating activation and derivative unit 16b, the weighting gradient calculation unit 16c, the derivative input multiplexer 16d, and the input multiplexer 16e are combined, the forward propagation operation, the weighting update operation, and the gradient operation can be performed.

FIG. 4B is an illustration of input/output pins of the third macro unit 16a of the third macro circuit 16 of the computing in memory accelerator 100. As mentioned previously, the third input terminal of the third macro unit 16a can be used for receiving the input feature information 16P3. For example, the input feature information 16P3 received by the third input terminal of the third macro unit 16a may include an input feature vector having (M+1) dimensions, denoted as input features 16in_0 to 16in_M in FIG. 4B. Further, the output terminal of the third macro unit 16a can be used to transmit the output signal 16P10. For example, the output terminal of the third macro unit 16a can be used to output an output vector having (N+1) dimensions, denoted as output signals 16out_0 to 16out_N in FIG. 4B. Further, the first output terminal of the third macro unit 16a is used for outputting the first variation information 16P6. The first variation information 16P6 can include (M+1) first derivatives, denoted as ∂C/∂a₀ to ∂C/∂a_{M} in FIG. 4B. Further, the definition of ∂C/∂A is the layer output gradient information, as previously mentioned. Thus, details are omitted here. The sixth input terminal of the third macro unit 16a is used for receiving the second variation information outputted by the derivative input multiplexer 16d. Specifically, the second variation information can include (N+1) second derivatives, denoted as ∂C/∂z₀ to ∂C/∂z_{N} in FIG. 4B. Similarly, the definition of ∂C/∂Z is the derivative information of the pre-activation gradient. The third macro unit 16a can further include a clock control terminal clk and a reset terminal rst. M and N are two positive integers. Residue input/output terminals of the third macro unit 16a are shown in FIG. 4A. Therefore, details are omitted there.

FIG. 4C is an illustration of generating outputs by linearly combining inputs of the third macro unit 16a of the third macro circuit 16 of the computing in memory accelerator 100. As mentioned previously, the input feature information 16P3 received by the third input terminal of the third macro unit 16a may include the input features 16in_0 to 16in_M. Further, the third input terminal of the third macro unit 16a can be used for receiving (M+1) weighting difference information, denoted as dw₀ to d_{W}^{M}. After the third macro unit 16a receives the weighting information 16P8 through the eighth input terminal, the third macro unit 16a can generate (M+1)×(N+1) weightings, denoted as W₀⁰ to W_{M}^{N}. Further, after (M+1) weightings of each column are linearly combined with the input feature vector having (M+1) dimensions, an output of the third macro unit 16a can be generated. For example, the output feature 16out_n can be expressed as:

$$16 out\_n = {\sum }_{i = 0}^{M} input i * {W}_{i}^{n}$$

As mentioned previously, the third macro circuit 16 can perform the weighting updating function. Therefore, after (M+1) weighting differences dw₀ to dw_{M} are received by the third input terminal of the third macro unit 16a, i-th updated weighting Wᵢⁿ′ of the n-th column can be expressed as:

$${w}_{i}^{n ′} = {w}_{i}^{n} - {dw}_{i}$$

In other words, for (M+1)×(N+1) weightings of the third macro circuit 16, the (M+1) weightings of each column can be updated according to the (M+1) weighting differences. As mentioned previously, in the third macro unit 16a, the (M+1) weightings of each column are linearly combined with the input feature vector having (M+1) dimensions. Therefore, in an (M+1)×(N+1) data mapping matrix, operations of each column can be regarded as (N+1) filters. Further, as mentioned previously, the third macro unit 16a can output (M+1) first derivatives GV1, denoted as ∂C/∂a₀ to ∂C/∂a_{M}. The third macro unit 16a can input (N+1) second derivatives GV2, denoted as ∂C/∂z₀ to ∂C/∂z_{N}. Correlations between ∂C/∂a₀ to ∂C/∂a_{M} and ∂C/∂z₀ to ∂C/∂z_{N} can be expressed as:

$$\frac{\partial C}{\partial {a}_{M}} = {\sum }_{i = 0}^{N} \frac{\partial C}{\partial {z}_{i}} * {w}_{M}^{i}$$

In other words, after the (N+1) second derivatives GV2 are linearly combined with (N+1) weightings of each row by the third macro unit 16a, the (M+1) first derivatives GV1 outputted from the first output terminal of the third macro unit 16a can be generated. Compared with the second macro circuit 15, the third macro circuit 16 has all functions of the second macro circuit 15. The third macro circuit 16 can further perform a function of computing gradient. Therefore, when the neural network requires performing a macro function of computing gradient, the third macro circuit 16 can be used.

To sum up, the present invention illustrates a computing in memory accelerator for applying to a neural network. The accelerator can perform an incremental learning operation. Specifically, the accelerator of the present invention uses three different macro circuits for performing functions of forward propagation, weighting update, and gradient operation. Further, three different macro circuits can be implemented by using different memory operations and digital circuit designs. Therefore, the accelerator of the present invention provides the following advantages, as described below. 1. Since the accelerator is the computing in memory accelerator, the latency of data communication between the memory and operation units can be reduced, thereby increasing data processing speed. 2. To support neural network inference, the accelerator can provide a function of training a neural network. Further, since different macro circuits are introduced to the accelerator, the performance of the neural network model can be continuously improved. 3. Since the accelerator is the computing in memory accelerator, the accelerator can provide flexible and efficient neural network training operations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computing in memory accelerator for applying to a neural network comprising:
a memory configured to save data;
a data buffer unit coupled to the memory and configured to buffer data outputted from the memory;
a pooling unit coupled to the memory and configured to pool data for acquiring a maximum pooling value;
a loss computing unit coupled to the memory and configured to compute output loss;
a first macro circuit coupled to the data buffer unit;
a second macro circuit coupled to the data buffer unit;
a third macro circuit coupled to the data buffer unit and the loss computing unit; and
a multiplexer coupled to the pooling unit, the first macro circuit, the second macro circuit, and the third macro circuit and configured to generate output data;
wherein an output terminal of the multiplexer is coupled to an input terminal of the memory.

2. The accelerator of claim 1, wherein the first macro circuit comprises:
a first macro unit comprising:
a first input terminal configured to receive address information;
a second input terminal configured to receive read/write control information;
a third input terminal configured to receive input feature information;
a fourth input terminal configured to receive activation information;
a fifth input terminal configured to receive weighting information; and
an output terminal; and
a calculating activation unit comprising:
a first input terminal coupled to the output terminal of the first macro unit;
a second input terminal configured to receive calculating activation mode information; and
an output terminal.

3. The accelerator of claim 2, wherein the input feature information comprises an input feature vector having (M+1) dimensions, the output terminal of the first macro unit is configured to output an output vector having (N+1) dimensions, the first macro unit further comprises a clock control terminal and a reset terminal, and M and N are two positive integers.

4. The accelerator of claim 3, wherein the first macro unit generates (M+1)×(N+1) weightings after the weighting information is received, and after (M+1) weightings of each column are linearly combined with the input feature vector having (M+1) dimensions, an output of the first macro unit is generated.

5. The accelerator of claim 1, wherein the second macro circuit comprises:
a second macro unit comprising:
a first input terminal configured to receive address information;
a second input terminal configured to receive read/write control information;
a third input terminal configured to receive input feature information;
a fourth input terminal configured to receive activation information;
a fifth input terminal configured to receive weighting update information;
a sixth input terminal configured to receive weighting information; and
an output terminal;
a calculating activation and derivative unit comprising:
a first input terminal coupled to the output terminal of the second macro unit;
a second input terminal configured to receive calculating activation mode information;
a third input terminal configured to receive first variation information;
a first output terminal; and
a second output terminal configured to output second variation information;
a weighting gradient calculation unit comprising:
a first input terminal coupled to the second output terminal of the calculating activation and derivative unit;
a second input terminal configured to receive the input feature information;
a third input terminal configured to receive an output control signal;
a fourth input terminal configured to receive a computing control signal; and
an output terminal configured to output third variation information; and
an input multiplexer comprising:
a first input terminal configured to receive the input feature information;
a second input terminal coupled to the output terminal of the weighting gradient calculation unit;
an output terminal coupled to the third input terminal of the second macro unit; and
a control terminal configured to receive a selection signal.

6. The accelerator of claim 5, wherein the input feature information of the second macro unit comprises an input feature vector having (M+1) dimensions, the output terminal of the second macro unit is configured to output an output vector having (N+1) dimensions, the second macro unit further comprises a clock control terminal and a reset terminal, and M and N are two positive integers.

7. The accelerator of claim 6, wherein the third input terminal of the second macro unit is further used for receiving (M+1) weighting difference information, the second macro unit generates (M+1)×(N+1) weightings after the weighting information is received, after (M+1) weightings of each column are linearly combined with the input feature vector having (M+1) dimensions, an output of the second macro unit is generated, and the (M+1) weightings of each column of the (M+1)× (N+1) weightings are updated according to the (M+1) weighting difference information.

8. The accelerator of claim 1, wherein the third macro circuit comprises:
a third macro unit comprising:
a first input terminal configured to receive address information;
a second input terminal configured to receive read/write control information;
a third input terminal configured to receive input feature information;
a fourth input terminal configured to receive first activation information;
a fifth input terminal configured to receive the second activation information;
a sixth input terminal;
a seventh input terminal configured to receive weighting update information;
an eighth input terminal configured to receive weighting information;
a first output terminal configured to output first variation information; and
a second output terminal;
a calculating activation and derivative unit comprising:
a first input terminal coupled to the second output terminal of the third macro unit;
a second input terminal configured to receive calculating activation mode information;
a third input terminal configured to receive first variation information;
a first output terminal; and
a second output terminal configured to output second variation information;
a weighting gradient calculation unit comprising:
a first input terminal coupled to the second output terminal of the calculating activation and derivative unit;
a second input terminal configured to receive the input feature information;
a third input terminal configured to receive an output control signal;
a fourth input terminal configured to receive a computing control signal; and
an output terminal configured to output third variation information;
an input multiplexer comprising:
a first input terminal configured to receive the input feature information;
a second input terminal coupled to the output terminal of the weighting gradient calculation unit;
an output terminal coupled to the third input terminal of the third macro unit; and
a control terminal configured to receive a selection signal; and
a derivative input multiplexer comprising:
a first input terminal configured to receive second variation information outputted from the loss computing unit;
a second input terminal coupled to the second output terminal of the calculating activation and derivative unit;
a control terminal configured to receive a selection signal; and
an output terminal coupled to the sixth input terminal of the third macro unit.

9. The accelerator of claim 8, wherein the input feature information of the third macro unit comprises an input feature vector having (M+1) dimensions, the output terminal of the third macro unit is configured to output an output vector having (N+1) dimensions, the first output terminal of the third macro unit is configured to output (M+1) first derivatives, the sixth input terminal of the third macro unit is configured to receive (N+1) second derivatives outputted from the derivative input multiplexer, the third macro unit further comprises a clock control terminal and a reset terminal, and M and N are two positive integers.

10. The accelerator of claim 9, wherein the third input terminal of the third macro unit is further used for receiving (M+1) weighting difference information, the third macro unit generates (M+1)×(N+1) weightings after the weighting information is received, after (M+1) weightings of each column are linearly combined with the input feature vector having (M+1) dimensions, an output of the third macro unit is generated, the (M+1) weightings of each column of the (M+1)×(N+1) weightings are updated according to the (M+1) weighting difference information, and after the (N+1) second derivatives are linearly combined with (N+1) weightings of each row by the third macro unit, the (M+1) first derivatives outputted from the first output terminal of the third macro unit are generated.
